(19) United States
(12) Patent Application Publication
(10) Pub. No.: US 2005/0073506 A1
(43) Pub. Date: Apr. 7, 2005

(54) C-frame slidable touch input apparatus for displays of computing devices

(76) Inventor: Nick P. Durso, Canyon Country, CA (US)

Correspondence Address: DAVID HONG, LAW OFFICE OF DAVID HONG, P.O. BOX 2111, SANTA CLARITA, CA, 91386, US

(21) Appl. No.: 10/929,750

(22) Filed: Aug. 29, 2004

Related U.S. Application Data
(63) Continuation-in-part of application No. 10/679,930, filed on Oct. 5, 2003.

(51) Int. Cl. G09G 5/00

(52) U.S. Cl. 345/173

(57) ABSTRACT

This invention provides a slipcover touch input apparatus and structure for displays for computing devices that converts a non-touch screen display to a touch screen display. The slipcover assembly acts as a sheath or cover for the display, and the touch screen is mounted in a window or opening of the casing of the display so that the touch screen is oriented to mimic the position of the display. This touch screen slipcover can convert any display of a computing device into a touch screen display.

### BACKGROUND OF THE INVENTION

1. Priority Information:

This application is a continuation in part of U.S. patent application Ser. No. 10/679,930, filed Oct. 5, 2003.

2. Field of the Invention:

This invention relates to a structure suitable for converting a non-touch screen display into a touch screen display comprising a slipcover for a display for computing devices and other electronic devices that not only protects the display but also allows for conversion of a regular or non-touch screen display to a touch screen display. By allowing for easy conversion of a regular or non-touch screen display to a touch screen display, the user will realize significant cost and time savings, adaptability, and convenience.

3. Description of Related Art:

Prior to the present invention, in order to convert a non-touch screen display to a touch screen display, the user needed to take apart and disassemble the display to install a touch screen. This touch screen installation required additional time and money for a user. In addition, due to the complexity of installation process of a touch screen to a display and the wide range of quality of different touch screens available in the marketplace, many users were not satisfied with the quality of the touch screen products and/or time required for installation.

From the preceding description, it is apparent that the devices currently being used have significant disadvantages. Thus, important aspects of the technology used in the field of invention remain amenable to useful refinement.

### SUMMARY OF THE INVENTION

The purpose of the present invention is to provide an easy and quick way to convert any display, including liquid crystal display (LCD) or flat-screen display, to a touch screen display without taking apart or disassembling the display. The present invention is placed, oriented, positioned, or slipped over the display to allow the non-touch screen display to become a touch screen display; there is also a connection from the internal circuitry or processing component(s) or controller of the touch screen to the computing device.

Another purpose of the present invention is to provide a slipcover that protects the display screen from physical injury or damage. Since the cost of displays or monitors or view screens for computing devices can be quite considerable, the slipcover can provide an economical way to protect the valuable display from injury or wear and tear.

Another purpose of the present invention is to allow for easy communication with a computing device with a touch screen interface. With the growing and popular use of mobile and laptop computers for presentations, this invention provides an easier input access through a touch screen than with using a stylus, mouse, or other external input device. This facilitation of the input process allows for maximizing the usefulness and portability of mobile computing.

Another purpose of the present invention is to provide an economical and affordable way to provide access to a touch screen to a single or multiple users. Since the invention can be removed and replaced on any display easily, this invention allows operators to best maximize their resources and to apply use of a touch screen when needed.

Another purpose of the present invention is to provide an easy and cost-effective way to convert a non-touch screen display to a touch screen display without having to physically take apart or disassemble the display and/or computing device to install a touch screen. For example, instead of having to convert many non-touch screen displays and integrated computer/display machines with an internally installed touch screen, the user simply needs to slip over the instant invention over the needed displays to make the necessary conversion into a touch screen displays.

Another purpose of the present invention allows for making computers more accessible to users with handicaps or disabilities that prevent them from accessing computers via traditional input devices such as the keyboard and the mouse. These particular touch screen users can take advantage of using a finger, stylus, or other easy to use input to engage the touch screen. Additionally, since the present invention facilitates the transformation of a regular non-touch screen display into a touch screen display, users with handicaps and/or disabilities are further able to enjoy the benefits of using touch screen input devices to access a computing device and the Internet.

The present invention introduces such refinements. In its preferred embodiments, the present invention has several aspects or facets that can be used independently, although they are preferably employed together to optimize their benefits. All of the foregoing operational principles and advantages of the present invention will be more fully appreciated upon consideration of the following detailed description, with reference to the appended drawings.

A structure suitable for converting a non-touch screen display into a touch screen display for a computing device comprising:
A web having at least one web surface,
At least two flanges extend from the web,
Each of said flanges has an arm,
The web incorporates a touch screen, a controller for the touch screen and a connection from the controller of the touch screen to the computing device,
The web, flanges, and arms define a space for slidably engaging the display, and
A software driver for the touch screen controller,
Whereby the web is slidably positioned over said display for the computing device such that the touch screen in the web is oriented directly over the display to convert a non-touch screen display to a touch screen display. The structure of claim 1 wherein said connection to said computing device is a USB, serial, firewire, wireless, and cable connection. The structure of claim 1 wherein said web has at least one hole on the flange of the web to allow for at least one wire to pass through the web to connect to the display for hanging.

A method of using an apparatus suitable for converting a non-touch screen display into a touch screen display for a computing device, said structure suitable for converting a non-touch screen display into a touch screen display for a computing device comprising a web having at least one web surface,
At least two flanges extend from the web,
Each of said flanges has an arm,
The web incorporates a touch screen, a controller for the touch screen and a connection from the controller of the touch screen to the computing device,
The web, flanges, and arms define a space for slidably engaging the display,
A software driver for the touch screen controller,
Comprising the following steps:
Sliding the web around the display into the space defined by the web, flanges, and arms;
Attaching the connection from the controller of the touch screen to the computing device,
Installing the software driver for the touch screen controller into the computing device, and
Whereby the touch screen in the web is oriented directly over the display to convert a non-touch screen display to a touch screen display.

### BRIEF DESCRIPTION OF THE DRAWINGS

FIG. 1 is a view of the invention placed over a mobile or laptop computer;

FIG. 2 is a rear view of the invention as shown in FIG. 1 on a mobile or laptop computer;

FIG. 3 is frontal view of the invention;

FIG. 4 is a rear view of the invention as shown in FIG. 3;

FIG. 5 shows another embodiment of the invention with a special pivoting stand in a second or open position;

FIG. 6 is a rear view of the another embodiment with a pivotable stand in a first or closed position;

FIG. 7 is a side view of the another embodiment with a pivotable stand in a second or opened position;

FIG. 8 is a rear view of another embodiment with a pivotable stand in a first or closed position.

FIG. 9 is a view of another embodiment on a stand alone display.

FIG. 10 is a side and cross-section view of another embodiment of the invention.

FIG. 11 is a frontal view of the C-Frame Slipcover embodiment of the invention with holes to allow wires or connections from a mounting surface to the display of a computing device.

FIG. 12 is a rear frontal view of the C-Frame Slipcover embodiment of the invention.

FIG. 13 is a side view of the C-Frame Slipcover embodiment of the invention employed on a display for a computing device.

FIG. 14 is a rear view of the invention being adjusted onto the display of a computing device.

FIG. 15 is a rear view of the invention being adjusted onto the display of a computing device.

FIG. 16 is a rear view of the invention placed upon a display for a computing device.

FIG. 17 is a front view of the invention placed upon a display for a computing device.

FIG. 18 is another frontal view of the invention with holes to allow wires or connections from a mounting surface to the display of a computing device.

FIG. 19 is side view of another embodiment of the claimed invention employing magnets.

FIG. 20 is a side view of another embodiment of the claimed invention using male and female attachment devices.

FIG. 21 is a side and cross-sectional view of another embodiment of the invention.

FIG. 22-26 are views of other embodiments of the invention.

### DESCRIPTION OF THE PREFERRED EMBODIMENTS

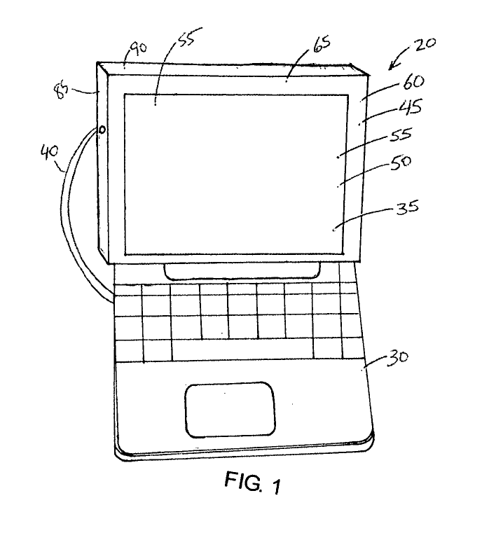

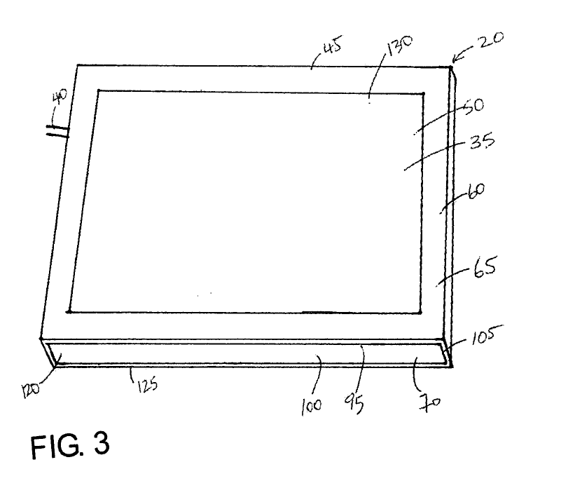

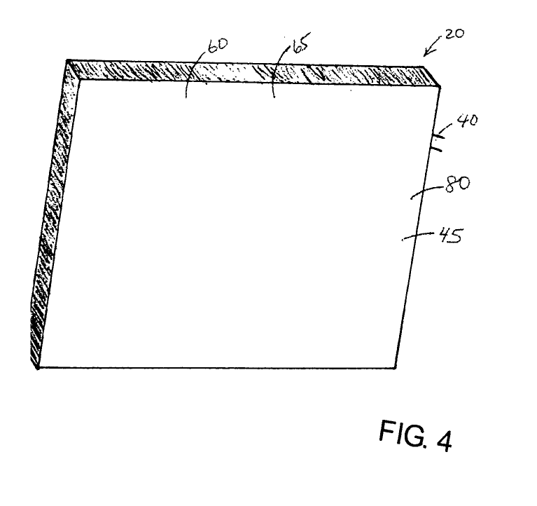

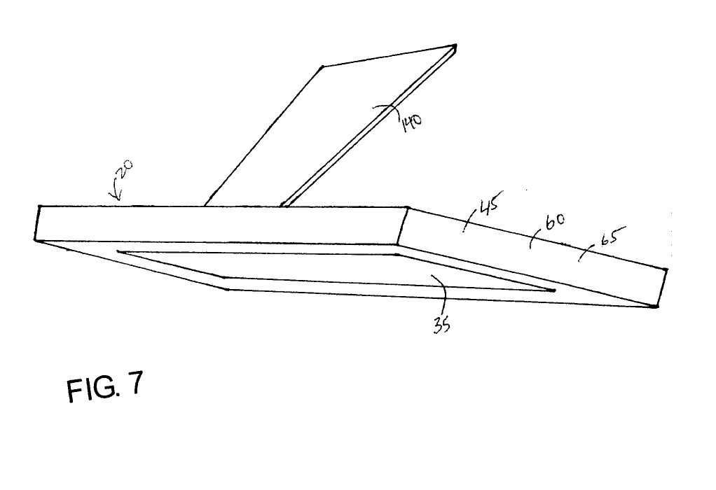

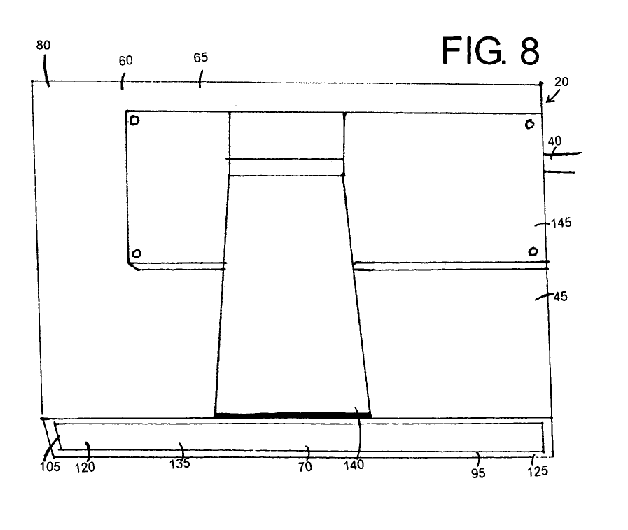

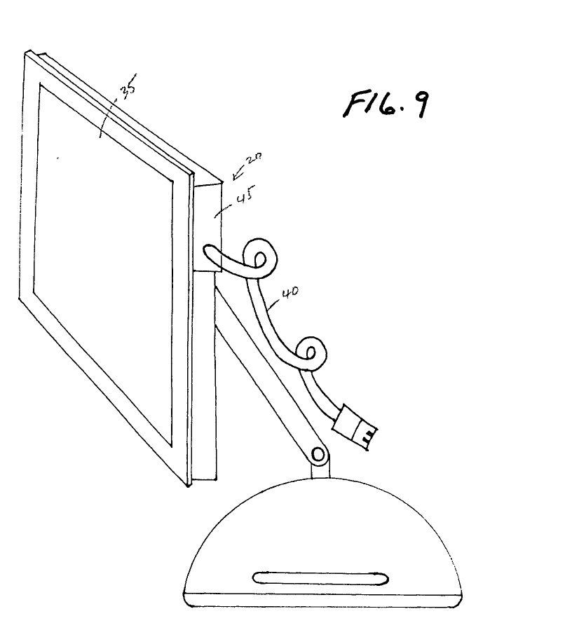

Referring to FIG. 1-8, there is illustrated a structure or a touch screen slipcover assembly 20 for adjustably converting a non-touch screen display 25, including but not limited to a liquid crystal display (LCD) and a flat-panel display, to a touch screen display.

The touch screen slipcover 20 for a computing device has a touch screen 35 on one surface; this slipcover slips over and acts like a sheath or surrounding cover or glove over and around the display 25 for a computing device 30. A connection 40, such as a Universal Serial Bus (USB) cord, connects a controller (not shown) of the touch screen (input device) to the computing device 30. The controller may be located on the back surface of the slipcover or integrated and compartmentalized within the slipcover casing 45. This invention will convert any non-touch screen display to a touch screen display to receive input from a user based on touch or pressure or other touch screen technologies.

As shown in FIG. 1, there is a slipcover assembly 20, which is placed over the screen display 25 of a computing device or computer 30. The slipcover assembly 20 or slipcover structure 20 comprises a casing 45. This casing 45 has a window 50 or opening 50 for a touch screen 35 to be mounted and to mirror the view screen 55 of the display 25. This window and opening 50 of the casing 45 should mimic the position, location, and orientation of the display 25 so that the touch screen 35 will align properly with the display 25 and the view screen 55 of the display 25. In other words, the touch screen 35 and casing 45 will fit like a glove over the display 25 of the computing device 30 so that the user can view the view screen 55 of the display 25 through the opening 50 of the casing 45.

Further, the casing substantially surrounds the display and covers the outer portions of the display body and the view screen. By substantially surrounding the display, the casing provides further stability and protection to the display and the touch screen apparatus. As a result, from general use, the slipcover touch input apparatus will not be maladjusted or knocked off from the optimal viewing position. Also, the slipcover assembly will remain on the display until the user decides and intends to remove the slipcover assembly.

In addition, in another embodiment, the casing 45 can also have a protective layer instead of a touch screen to sit in the window or opening 50. This protective layer can be a glass, plastic composite, or a see-through mesh. In addition, this protective layer may also provide protection from interference or glare.

The casing 45 has at least one casing surface 60. In one embodiment, the casing 45 can have all smooth surfaces and avoid having edges, so that there is only one casing surface 60 around the slipcover assembly 20. In other embodiments, there will be multiple casing surfaces, including inner and outer casing surfaces and this invention is not to be limited by the number of casing surfaces.

As shown in FIG. 1-4, there is at least one outer casing surface 65 and at least one inner casing surface 70. In FIG. 1-4, there is a first outer casing surface 75, a second outer casing surface 80, a third outer casing surface 85 (height), and a fourth outer casing surface (width) 90. In FIG. 1-4, there is also a first inner casing surface 95, a second inner casing surface 100, a third inner casing surface 105, and a fourth inner casing surface 110.

In addition, depending on how the touch screen 35 is placed within the casing window or opening 50, there may also be at least one casing window surface. The touch screen 35 may be flush with the at least one casing outer surface 65. In addition, the touch screen 35 may also be slightly below or above the at least one casing outer surface 65. The touch screen 35 can be installed to different heights in relation to the at least one outer casing surface 65.

The outer casing surfaces and the touch screen 35 form a shell or sheath or a partially enclosed space 120, which will slip around the display 25. The display 25 will act as a male piece, which will fit into the slipcover assembly 20, which will act as a female piece. The second casing outer surface 80 lies opposite to the touch screen 35. In addition, there is also a casing connection surface 125, which lies opposite to the fourth inner casing surface and fourth outer casing surface 90.

Additionally, the casing comprises at least one outer casing surface and at least one inner casing surface, whereby the at least one outer casing surface and the at least one inner casing surface define a space 120 for the display to fit and to substantially occupy.

Materials for the Casing:

The casing 45 can be made of a variety of different materials, such as a plastic or a composite, including a plastic composite. Also, the casings may employ an alloy or metal composite or a carbon fiber material. The casing material should be lightweight, yet sturdy and durable, and the casing possibly could be made of wood fibers or a cardboard composite.

Basic Touch Screen:

A basic touch screen typically has three main components: (1) touch screen or sensor; (2) a controller; and (3) software driver. A typical touch screen sensor employs a clear glass panel with a touch responsive surface. This touch screen sensor is placed and oriented over the display of the computing device (computer, DVD, gaming, kiosk, register, or other computing machine) so that the responsive area of the touch screen panel covers the viewable area or view screen of the display.

Through some sort of physical or wireless connection, a controller communicates the input data from the touch screen or sensor to the computing device. This controller (typically a computing card) may be integrated into the display or computing device. This controller may be mounted internally or externally to either the touch screen structure or the computing device or within an external structure. Some computing devices may require specialized controllers to connect the computing device to the touch screen.

The computing device may employ software or software drivers to interpret the input information from the touch screen that is sent from the controller. Some computing devices may not require separate software drivers or employ their own built-in touch screen software drivers.

Touch Screen:

The instant touch screen 35 or touch sensor 35 has an outer touch screen surface 130 and an inner touch screen surface 135. This invention is not limited to any particular type of touch screen or pressure sensitive input device.

This instant invention can incorporate a wide variety of different types of touch screens and pressure sensitive input devices. Examples of different kinds of touch screens and touch sensor technologies are Surface Acoustic Wave (SAW), Near Field Imaging, Capacitive, Analog Resistive; 5-Wire Resistive; 4-Wire Resistive; Pen-Touch Capacitive; and Infra-Red (IR). Typically, a sensor generally has an electrical current or signal passing through; touching the sensor screen causes a voltage or signal change; this voltage or signal change is used to determine the location (including 2-dimensional position) of the input or touch to the sensor screen. These types of touch screens are for example only and are not intended to limit the scope of different kinds of touch screen input devices that can be used with the instant invention.

In addition, the touch screen 35 and the casing window 50 imitate and mimic the position and the dimensions of the display 25. The touch screen 35 should be able to be mounted, installed, positioned, and fitted within the window or opening 50 of the casing 45. As shown in FIG. 1, the touch screen slipcover assembly or structure 20 is placed and positioned substantially over the display 25 as a sheath or similar to a pillowcase over a pillow. The slipcover assembly 20 substantially surrounds the display of the computing device, including the view screen and much of the body of the display body. The view screen 55 of the display 25 will appear through the opening or window 50 of the casing 45, and the touch screen will substantially cover the view screen of the display 25. By mimicking, imitating, and simulating the position, orientation, and dimensions of the display 25, the touch screen slipcover assembly 20 can allow the non-touch screen display to become a touch screen display and allow the user to see through the touch screen to the display view screen.

Connection from Touch Screen to Computing Device:

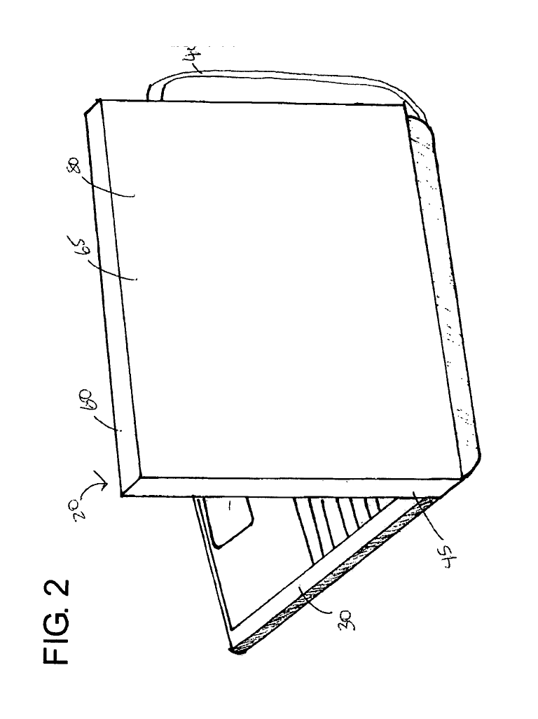

There is a connection 40 to link the touch screen slipcover 20 to the computing device 30. As shown in FIG. 1-2, there is a wire connection 40 from the internal circuitry or controller of the touch screen to the computing device 35. This can be a variety of different connections such as Universal Serial Bus (USB), Fire Wire, serial cable, fiber optic cable, and wireless. This invention is not to be limited by the type of connection device, but this invention can use any possible connection from the touch screen to the computing device—physical or wireless connection.

In addition, in another embodiment, the touch screen slipcover may have a connection that fits within one of the outer surfaces of the casing or within the casing connection surface 125. For example, the slipcover 20 would have a male connection that would fit within a female connection on the computing device. Or, the slipcover would have a female connection that would accept a male connection from the computing device.

In another embodiment, the connection 40 between the touch screen slipcover and the computing device would not require a physical connection but could take advantage of wireless technology such as radio signals or infrared communication.

Slipcover for Stand Alone Display:

The slipcover touch screen assembly can be applied to a stand-alone display, such as a liquid crystal display (LCD) or flat-screen display or even a Cathode Ray Tube (CRT) display. As with the slipcover assembly for mobile computers, the slipcover assembly for stand-alone displays would use similar connection elements as described above. This embodiment of the invention would slip over the stand-alone display, just like the embodiment for mobile or laptop computer displays.

This particular invention is considered for flat-screen or LCD displays due to the thin nature of these displays, but this invention should not be simply limited to these types of displays. This invention could be applied to other types of displays, such as large and bulky displays and plasma displays, and the slipcover dimensions would have to mimic and to imitate the display dimensions and position of the view screen accordingly. In addition, it is also possible to convert large view displays into touch screen displays.

Built-In Stand:

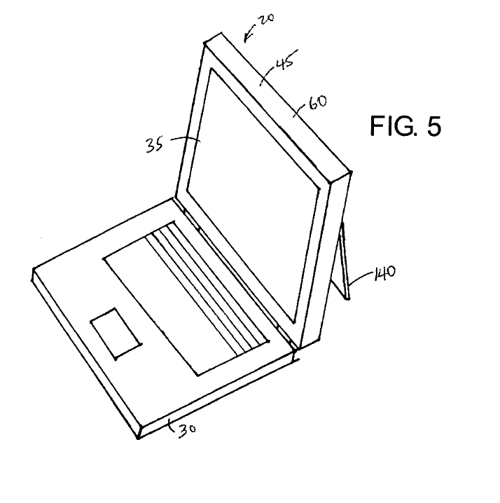

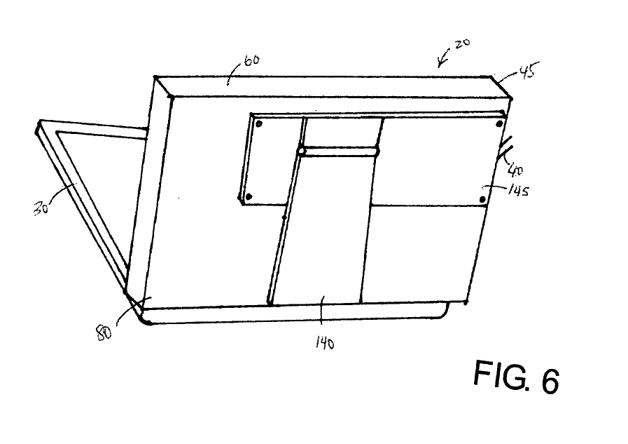

As shown in FIG. 5-8, the slipcover assembly may also have a built-in stand or strut 140 on the second casing outer surface 80. This adjustable stand or support 140 has a first or closed position (see FIG. 6) and a second or opened position (see FIG. 5). In the first position, the stand 140 lies flush against the second casing outer surface 80. In the second position, the stand is pivoted and can be swung out to form an angle (typically, less than 90-degrees, but may be greater) from the second casing outer surface 80. This stand 140 will help support the slipcover assembly 20 and the display 25. The stand 140 can lean against the table, desk, or counter surface upon which the laptop or mobile computer lies. The stand may be positioned opposite to the opening 50 of the casing. The stand can be adjusted to a variety of different positions to allow for optimal viewing of the touch screen and the display.

This embodiment may employ one pivotable or adjustable stand 140 or a multitude of pivotable or adjustable stands. In the first position, the stand or stands 140 will be flush or hidden within the casing 45 or rest just above the casing surface 80. In the second position, the user will pull out and pivot the stand(s) 140 so that the stand(s) 140 will help support the weight of the slipcover assembly 20, including the touch screen and casing) and the display 25 in order to maintain an optimal and comfortable viewing angle for the user of the touch screen and display.

In addition, the stand 140 may also be detachable from the casing surface 80 so that the user may attach or detach the stand 140 depending on use and need. The stand 140 may also be pivotally integrated into the casing body so that in the first position, the stand will be held flush against the casing outer surface. In the second position, the user can pull out the stand 140.

Touch Screen Circuitry Outer Box:

The circuitry or controller for the touch screen can be placed on a box or compartment 145 on the casing outer surface 65. In addition, this circuitry or controller for the touch screen can be internalized in the casing 45 so that there are no circuitry storage areas or box 145 that break the casing outer surface 65.

Anti-Theft Device or Lock for Slipcover:

This present invention allows for a lock to be placed on the slipcover and connected to a stationary object to avoid theft of the slipcover. In one embodiment, a hole is drilled into the casing so that a padlock or any other type of lock can secure the object from being moved or stolen. This anti-theft device is significant because the slipcover can be so easily installed and removed. Also, the user may also require that the touch screen slipcover be used for different employees with different computers. This allows for some flexibility in how users use their slipcover touch screen adapter for their computer equipment.

Another embodiment allows for an anti-theft deterrent device such as an alarm or an anti-motion sensor that would be activated if the structure is moved unintentionally.

Non-Touch Screen Embodiment:

In addition, this invention can also use a non-touch screen in the window or opening of the casing. This non-touch screen embodiment would act as a protective sheath or guard for the display. Since many current LCD or flat-screen displays are quite expensive, it would be prudent for users to protect their displays. In addition, the non-touch screen embodiment can use filters or see-through screens in the window to reduce glare on the display.

Method of Use:

To use the touch screen slipcover assembly 20, the user simply places the slipcover assembly 20 or casing with touch screen substantially over the display 25 of the computing device 30 so that the display view screen 55 is shown through the casing opening/window 50 and is covered by the touch screen 35. The user will connect the touch screen internal circuitry or processing components or controller to the computing device 35 with a physical connection 40 or with a wireless connection. Then, the non-touch screen display is automatically converted to a touch screen display.

If required, the user may also install software to allow the computing device and the controller to exchange and to interpret the input information from the touch screen sensor.

Further, if installed, the user may also pull out, pivot, adjust, and extend a stand from the casing outer surface to help support the slipcover assembly and the display (from a first position or closed position to a second or open position).

This invention is very useful because it provides an easy and cost-effective way for a user to convert a non-touch screen display to a touch screen display. The user has a tremendous amount of flexibility and ease of use because the touch screen slipcover assembly can be placed over several different computing device displays.

The user is able to save time and money with this invention and avoids having to transport his or her display and/or computing device to an installer and/or integrator to have the touch screen installed into the display. With the locking embodiment, the user is also able to securely fasten the slipcover assembly to the display.

The applications for touch screen displays are numerous in the military, retail, professional, and residential areas. With the growth of sophistication of computer input devices evolving from keyboards and mouse(s) to graphic user interfaces and touch screen devices, this invention provides a cost-effective and elegant solution to provide the user access to the added functionality and convenience of using a touch screen input device and interface with the computing device.

### Kit for Slipcover Touch Input Apparatus for Displays for Computing Devices

The invention also applies to a kit that can be sold to the consumer to allow an easy and quick conversion of any display for a computing device to a touch screen display. For example, the kit would include installation instructions, the touch screen casing with touch screen or protective lens or film to fit within the opening or window of the casing; a connection (physical or wireless) from the touch screen internal circuitry to the computing device; and any required software drivers. In addition, there also may be touch screen cleaning materials such as solution or wipes. There may also be a detachable, pivotable, and adjustable stand for the casing as well.

A structure suitable for converting a non-touch screen display into a touch screen display for a computing device comprising: a touch screen; a casing; the casing having an opening for the touch screen; at least one casing surface; a controller for the touch screen; a connection from controller of the touch screen to the computing device, whereby the casing is positioned over and substantially around the display for the computing device such that the touch screen in the casing opening is oriented directly over the display to convert a non-touch screen display to a touch screen display. The connection to the computing device is a Universal Serial Bus, Fire Wire, wireless, and cable connection. The casing further comprises at least one outer casing surface and at least one inner casing surface, whereby the at least one outer casing surface and the at least one inner casing surface define a space for the display to fit. The casing comprises a plastic composite. The casing further comprises at least one pivotable stand, which is positioned opposite to the opening of the casing, whereby the at least one stand supports the structure and the display.

A structure suitable for converting a non-touch screen display into a touch screen display for a computing device comprising: a touch screen; a casing; the casing having an opening for the touch screen; at least one casing surface; a controller for the touch screen; a connection from controller of the touch screen to the computing device; the casing surface having at least one pivotable stand, whereby the casing is positioned over and substantially around the display for the computing device such that the touch screen in the casing opening is oriented directly over the display to convert a non-touch screen display to a touch screen display and whereby the at least one stand supports the casing and the display.

A method of using structure suitable for converting a non-touch screen display into a touch screen display for a computing device, said structure comprising a touch screen; a casing; the casing having an opening for the touch screen and at least one outer casing surface and at least one inner casing surface; the at least one outer casing surface and the at least one inner casing surface further defining a space for the display; a controller for the touch screen; a connection from the controller of the touch screen to the computing device, comprising the following steps: (1) placing the casing over and substantially around the display into the space defined by the at least one outer casing surface and the at least one inner casing surface; and (2) attaching the connection from the controller of the touch screen to the computing device, whereby the touch screen in the casing opening is oriented directly over the display to convert a non-touch screen display to a touch screen display. The method further comprises installing a software driver for the touch screen into the computing device. The method further comprises moving a pivotable stand on the casing from a first closed position to a second opened position.

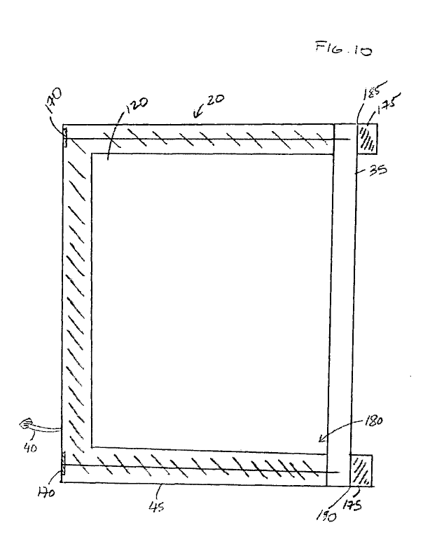

Embodiment as Shown in FIG. 10:

There is another embodiment of the invention, as shown in FIG. 10 (cross sectional diagram; not drawn to scale). There is a casing or web 45 having an opening for the touch screen. The casing is c-shaped to form an open end 180 or opening for the touch screen; please note that in this particular embodiment, the shape of the web/casing is c-shaped, but this invention allows for various types of shapes, which can mimic or shadow the contours of the display of the computing device.

The touch screen 35 is placed at the open end 180 or opening of the casing; this touch screen can be attached with glue, adhesive, physical attachments such as nuts, bolts, and screws to the casing opening.

In one particular embodiment, the nuts, bolts, or screws 170 are inserted through the rear or closed end of the casing, pass through the side walls of the casing, and finally connect and secure the touch screen to the casing/web opening.

Since most touch screens are see-through and transparent, another covering 175 or framing layer can be attached, laminated, connected to the peripheral edges (185, 190) of the touch screen 35 to cover up any indications of any attachment devices 170 (such as screws or bolts). This outer covering 175 that frames the peripheral edges of the touch screen can be made of any type of material, including but not limited to mylar laminate or other plastic or metal compositions, which can be easily attached to the touch screen with adhesive or other attachment methods. This laminate layer 175 may also be a source for product and manufacturer identification, labeling, or advertisement; the outer framing layering covering creates an aesthetically pleasing presentation to touch screen slipcover apparatus.

This particular embodiment is very useful not only during manufacturing but also during any maintenance for the product. For any maintenance of the touch screen, the user would simply unscrew or unbolt the casing/web from the touch screen; the user would separate the touch screen from the casing and can easily send or bring the touch screen to the manufacturer for repair, upgrade, or replacement.

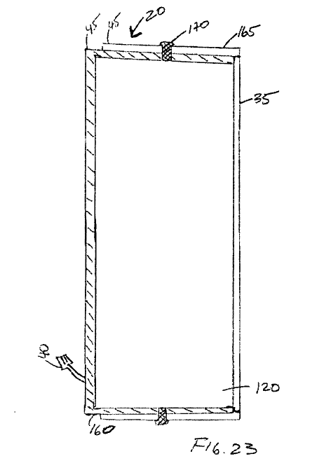

In another embodiment of this invention (see FIG. 22), the casing is comprised of a male piece 160 and a female piece 165. The female piece houses the touch screen 35 and an opening 55 for the touch screen. The female piece 165 would have at least one flange 167 extending from the peripheral edges 169; there can be a first and second peripheral edge of the flange of the female piece; there can be a first flange and second flange of the female casing piece. These flanges 167 would create a guide for the insertion of the male piece 160 of the casing.

The touch screen can be mounted at any height or elevation relative to the female part of the casing, but the touch screen should be mounted such that proper alignment with the underlying view screen of the display is optimized. The two male and female casing pieces can be connected with any attachment device 170, including but not limited to hook and loop attachments, screws, nuts, bolts, clips, buttons, clasps, and adhesive.

This embodiment would further enable easy manufacturing and maintenance because this apparatus can be constructed of two pieces of casing and the touch screen and controller with connection to the computing device. In FIG. 22, the controller of the touch screen is not shown but would be included in such an apparatus; there would also be connections from the touch screen to the controller and from the controller to the computing device. A software driver for the touch screen controller would also need to be installed into the computing device as well. Element 40 shows a connection from the touch screen device to a computing device.

C-Frame Slidable Touch Screen:

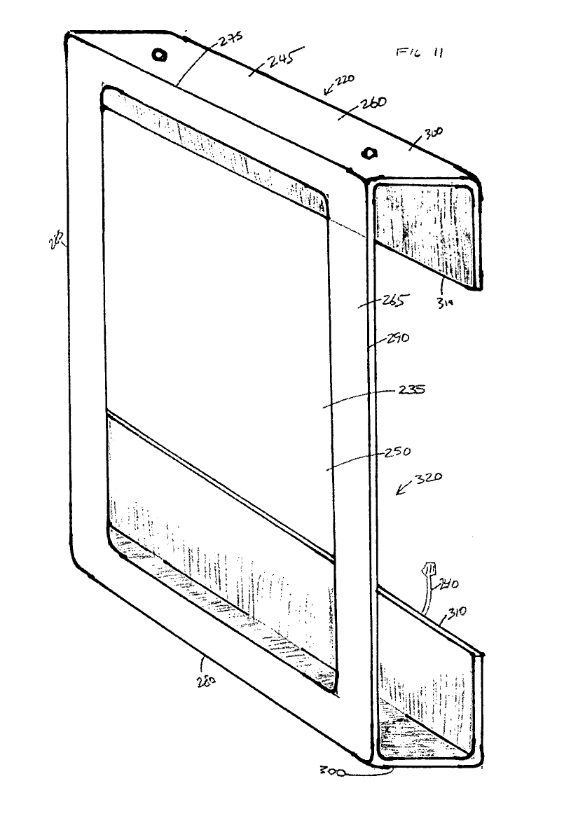

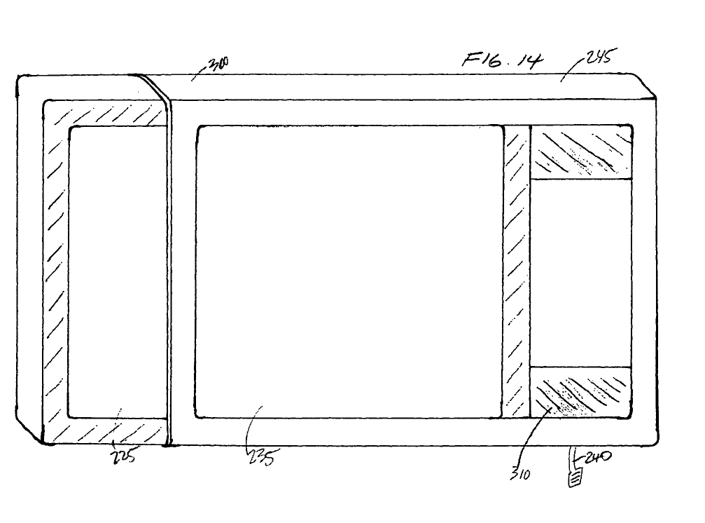

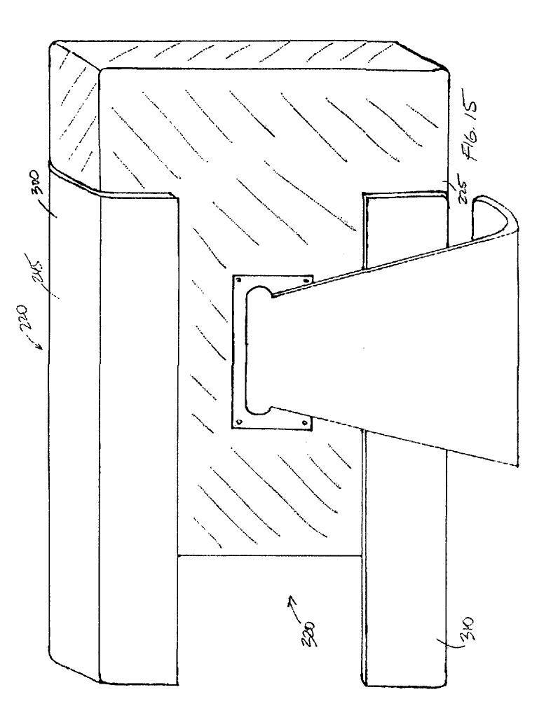

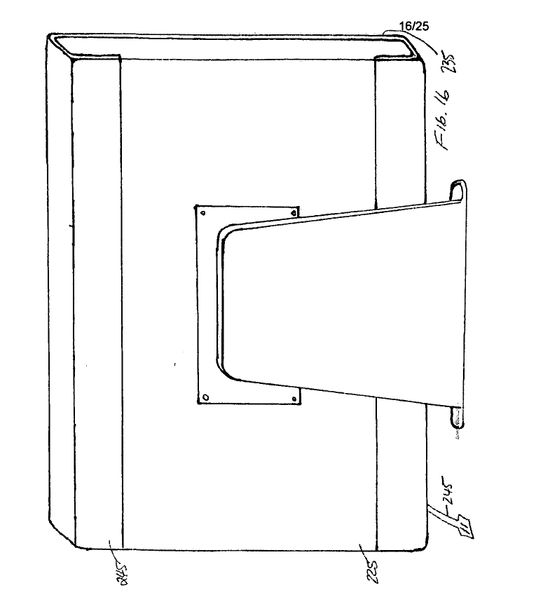

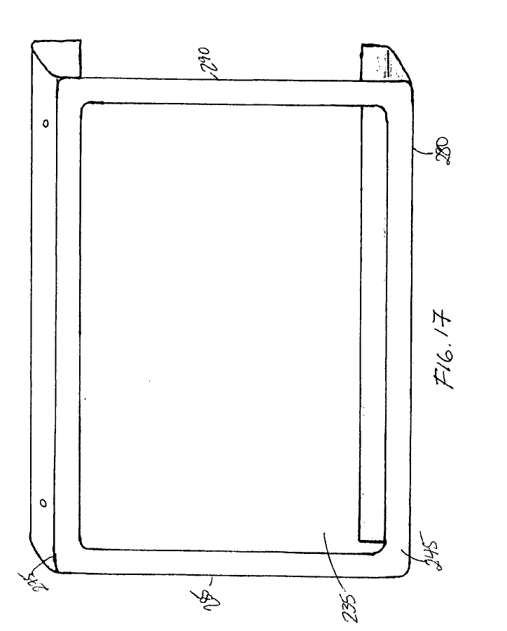

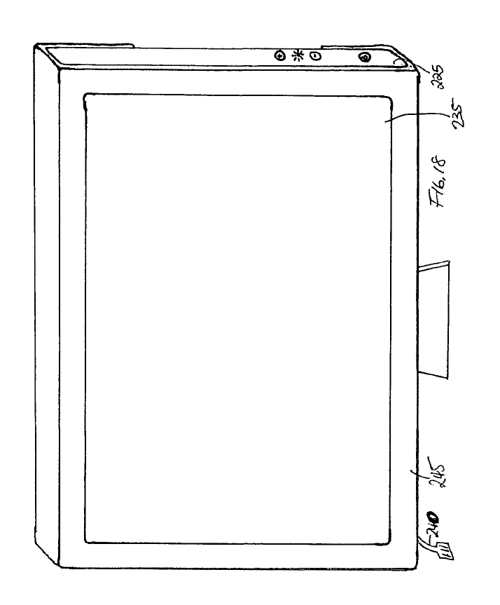

Referring to FIG. 11-20, there is illustrated another embodiment of this invention: a structure or a C-frame touch screen slipcover assembly 220 for adjustably converting a non-touch screen display 225, including but not limited to a liquid crystal display (LCD), a flat-panel display, cathode ray tube (CRT) display, and a gas plasma display, to a touch screen display.

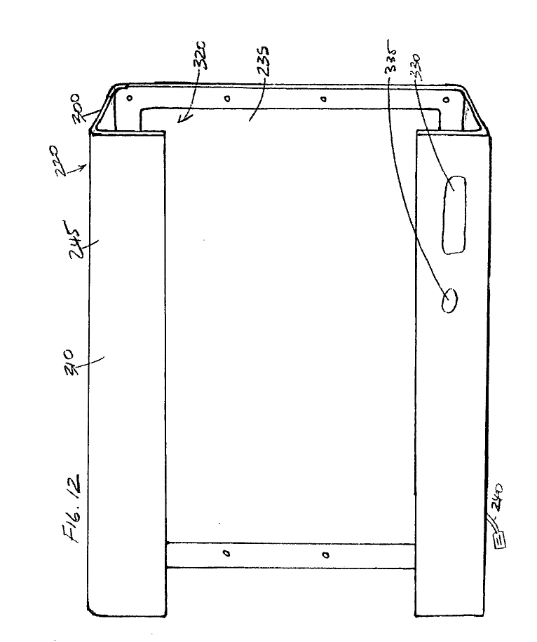

The C-frame slipcover assembly 220 for a computing device has a touch screen 235 on one surface; this C-frame slipcover 220 adjustably slides onto and along one axis of the display (x-axis). The C-frame slipcover 220 acts like a partial mask, sheath, or cover to cover, envelop, wrap, shroud, or veil the view screen 255 of the display for computing devices such that the touch screen of the C-frame slipcover mimics, aligns and orients with the view screen of the display. This C-frame slipcover assembly may partially cover the peripheral ends of the display. In addition, other embodiments of this invention may have the assembly substantially cover the peripheral ends and the rear of the display (See FIG. 12).

A connection 240, such as a Universal Serial Bus (USB) cord, connects a controller (not shown) of the touch screen (input device) to the computing device 30. The controller may be located on one of the surfaces of the C-frame slipcover or integrated, compartmentalized, or hidden within the slipcover casing or web 245. This invention will convert any non-touch screen display to a touch screen display to receive input from a user based on touch or pressure or other touch screen technologies.

As shown in FIG. 11-20, there is a C-frame slipcover assembly 220, which is capable of being installed onto the display 225 of a computing device or computer 230 and along one axis or along an X-axis of the display or computing device or combination display and computing device. An easy way for installation is simply sliding the C-frame slipcover assembly 220 onto the display 225 along one axis of the display, typically, but not limited to, the x-axis or horizontal axis.

The user would additionally connect the touch screen's controller to the computing device and/or computing device display with a physical connection (USB, SAW, Serial, or firewire, etc.) or a wireless connection; the user would also need to install the proper software drivers for the touch screen. This invention also can be employed with computing devices that have their own controller and software drivers to communicate and to operate with a computing device and display.

Casing/Web 245

The C-frame slipcover assembly/structure 220 comprises a casing or web 245. The casing/web 245 has at least one casing/web surface 260; the casing/web 245 may further have a first casing/web proximal edge 275 and a second casing/web proximal edge 280. The first and second web/casing proximal edges are oriented along the same X-axis of the display.

The casing/web 245 may further have a third casing/web proximal edge 285 and a fourth casing/web proximal edge 290. The third and fourth web/casing proximal edges are oriented along the same Y-axis of the display.

Position of Touch Screen

This casing or web 245 can have a window or opening 250 for a touch screen 235 to be mounted and to mirror the view screen 255 of the display 225. This window and opening 250 of the casing 245 should mimic the position, location, and orientation of the display 225 so that the touch screen 235 will align properly with the display 225 and the view screen 255 of the display. In other words, the touch screen 235 and casing/web 245 will cover, envelop, shroud, or veil the front or first surface of the display 225 of the computing device 230 so that the user can see the view screen 255 of the display 225 through the opening 250 of the casing 245 and through the touch screen.

Flange and Arms of Casing/Web:

The casing or web further has flanges 300 extending from the first and second casing/web proximal edges. There is at least one flange extending from first casing/web proximal edge 275 and at least one flange extending from the second casing/web proximal edge 280. There are other embodiments possible with only one flange extending from either the first or second casing/web proximal edge. The preferred embodiment of this invention employs at least one flange to extend from both the first and second casing/web proximal edge.

The flange can be at any angle relative to the casing outer surface; this flange can further mimic the shape or outline of the underlying display for computing device to allow for a better fit and accommodation. In addition, there can be multiple flanges formed when there are slots or grooves from the proximal web/casing edge through the flange.

Extending from each of the flanges, there is an arm 310. The arm can mimic or be oriented parallel to the display surface such that the combination of the casing/web inner and outer surfaces, flange and arm define a space 320 for the display for computing devices to fit, to occupy, within to slide, and to reside.

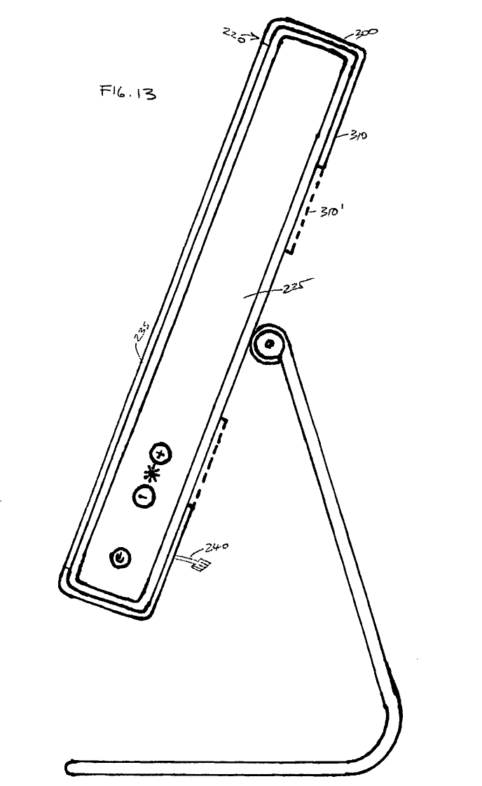

Like the flange, the arm can be at a variety of different angles relative to the flange. However, the arm and the flange should act in concert together to help define a space for the display, in conjunction with the web surfaces. Also, the arm can cover different amounts of surface area of the rear of the display (see FIG. 13). The amount of coverage can depend on the specific need and size of the particular application or display.

Further, the casing or web can substantially surround the display and cover the outer portions of the display body and the view screen. By substantially surrounding the display, the casing or web can provide further stability and protection to the display and the touch screen apparatus. As a result, from general use, the C-frame slipcover touch input apparatus will not be maladjusted, misaligned or knocked off from the optimal viewing position. Also, the C-frame slipcover assembly 220 will remain on the display 225 until the user decides and intends to remove the slipcover assembly.

In addition, there can also be access points in the web, see FIG. 12, elements 335 and 330 for input and output ports and security ports for locking mechanisms.

Display Protective Layer

In addition, in another embodiment, the casing or web 245 can also have a protective layer instead of a touch screen to sit or be positioned within the window or opening 250. This protective layer can be a glass, plastic composite, or a see-through mesh. In addition, this protective layer may also provide protection from interference or glare.

This invention allows for various manufacturing methods; for example, the touch screen may be integrated at different elevations relative to the casing/web and/or protective layers (i.e., felt or sliding material or attachment devices on the inner casing/web surface) and/or outer ornamental covers. No matter the particular manufacturing method, the basic invention allows for a removable touch screen to be easily attached to any computing display with the above mentioned structures.

Web/Casing Surfaces

The casing or web 245 has at least one casing surface 260 or at least one web surface 260. In one embodiment, the casing or web 245 can have all smooth and uninterrupted surfaces and avoid having edges, so that there is only one casing or web surface 260 around the C-frame slipcover assembly 220. In other embodiments, there will be multiple casing or web surfaces, including inner and outer casing or web surfaces, and this invention is not to be limited by the number of casing or web surfaces.

As shown in FIG. 11-20, there is at least one outer casing or web surface 265 and at least one inner casing or web surface 270. There is a first outer casing or web surface, a second outer casing or web surface (outer or first flange surface), and a third outer casing or web surface (outer or first arm surface). There is also a first inner casing surface, a second inner casing surface (inner or second flange surface), and a third inner casing surface (inner or second arm surface).

The inner casing surface may employ felt or non-scratching material in order to avoid scratching or damaging the outer surface or case of the display 225, the inner casing/web surfaces of this invention can be lined with felt or other non-scratching material that will not scratch or damage the outer surface or case of the display. This material may also allow the C-frame slipcover assembly to smoothly slide onto the display during installation/mounting and removal. Some non-limiting examples are fabrics or plastics and composite materials.

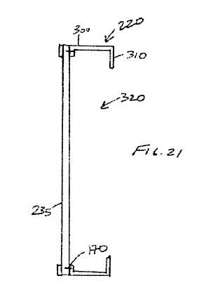

Other embodiments may employ using male and female attachment devices, as shown in FIG. 20. For example, the inner casing/web surface of the apparatus may have grooves, which would complement ridges on the outer surface of the display. The ridges or grooves can be interchangeable on the outer surface of the display or touch screen apparatus casing.

Web/Casing Window Surface

In addition, depending on how the touch screen 235 is placed within the casing or web window/opening 250, there may also be at least one casing/web window surface. The touch screen 235 may be flush with the at least one casing/web outer surface 265. In addition, the touch screen 235 may also be slightly below or above the at least one casing/web outer surface 265. The touch screen 235 can be installed to different heights in relation to the at least one outer casing/web surface 265.

The outer casing/web surfaces and the touch screen 235 form a shell or sheath or a partially enclosed space 320, which will slip substantially around or slide onto the display 225. The display 225 will act as a male piece, which will fit into the C-frame slipcover assembly 220, which will act as a female piece.

Additionally, the casing/web 245 comprises at least one outer casing/web surface and at least one inner casing/web surface, whereby the at least one outer casing/web surface and the at least one inner casing/web surface define a space 320 for the display to fit and to substantially occupy.

Materials for the Casing:

The casing/web 245 can be made of a variety of different materials, such as a plastic or a composite, including a plastic composite. Also, the casing or web may employ an alloy or metal composite or a carbon fiber material or a brushed aluminum. The casing material should be lightweight, yet sturdy and durable, and the casing possibly could be made of wood fibers or a cardboard composite.

Another Embodiment Based the “C-Frame” Apparatus:

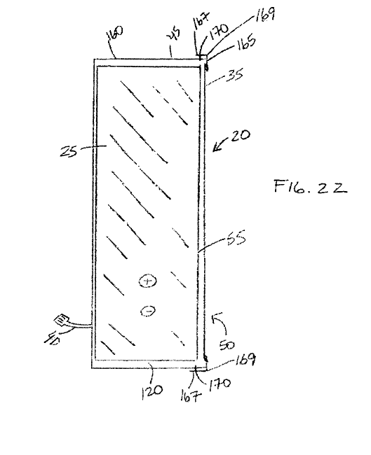

As shown in FIG. 21, there is another embodiment of the claimed invention. Instead of a single web/casing, there are two flanges 300: a first flange and a second flange. Each flange may have an arm 310. A space 320 for the display is created from the web/casing, touch screen, flanges, and arms. In this embodiment, for the simplicity of manufacturing and maintenance, each flange is connected to the peripheral edges of the touch screen with some connection device 170, including but not limited to screws, bolts, adhesive, hook and loop connectors, buttons, and clips.

As shown in FIG. 21, a connection device, such as a screw, is inserted through the flange or arm to securely connect the peripheral edge of the touch screen. Since the touch screen is see-through and transparent, this invention may also employ an ornamental or protective covering 175 such as mylar laminate or any other cover as mentioned above, which can be attached to the touch screen peripheral edges, to cover the attachment screw or bolt.

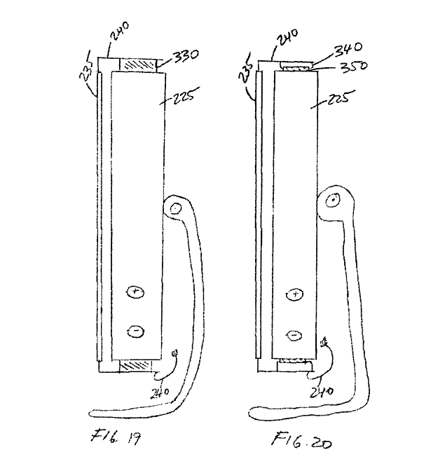

Similar to the embodiments shown in FIG. 19-20, other embodiments employ a flange without using an arm; these embodiments will just have a flange and the inner surface of the flange will have some sort of connection device to keep the apparatus on the display. These connection devices can include magnets, hook and loop connectors, and male and female connective pieces. In the preferred embodiment, there is a web or at least two connections (flange alone or flange/arm combinations) that will stabilize and hold the touch screen over the view screen of the display.

Y-Axis Embodiment Possible:

Please note there are other embodiments of this invention, which allow the web to slide along an alternate axis, such as a y-axis. This alternate axis may have some attachment devices along at least one edge of the web to prevent the web from sliding from a position of proper alignment of the web with the display. These attachment devices can act like hooks over the frame of the display; also, other attachment devices could employ magnets or hook and loop type attachments or other suitable attachments.

Embodiment without Arms:

This invention also contemplates an embodiment with the casing and flange and no arms. As shown in FIG. 19-20, there is a casing with a first and second proximal edge. From at least one edge, there is at least one flange. To maintain stability, the flange inner surface may have magnets 330 to attach to the display in a removable fashion as shown in FIG. 19. Other removable attachments can be hook and loop attachments, male and female attachments, 340, 350(see FIG. 20), stickers, clasps or other removable attachment apparatus.

Other embodiments have each proximal edge having at least one flange. Each flange would have at least one flange surface; if there is a first flange surface (outside) and a second flange surface (inside), then the second flange surface would employ removable attachment devices such as magnets, hook/loop, clasps or other easy to use attachment devices. Like the embodiments above, the flanges may have slots or grooves, and there also can be embodiments with multiple flanges arising from the same proximal casing edge.

Another application for this invention involves using the slipcover touch screen apparatus invention not only for stand alone, desktop, or laptop computing displays, but also for hand held or portable or mobile computing displays, cellular phones, personal digital assistants (PDA), or other computing and communication devices. This invention also allows for use not only computing devices, but also for gaming devices and for computer access devices for the physically challenged or handicapped individuals.

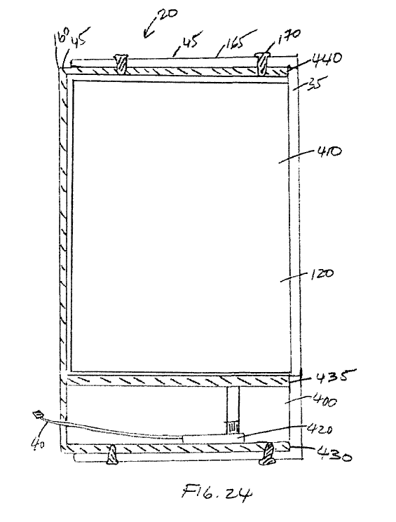

Embodiment in FIG. 23:

As shown in FIG. 23, there is another embodiment wherein the apparatus for converting a non-touch screen display into a touch screen display comprising a casing, which is comprised of a male piece 160 and a female piece 165. The female piece houses the touch screen and an opening for the touch screen. The female piece would have a flange extending from the peripheral edges. These flanges would create a guide for the insertion of the male piece of the casing.

The touch screen can be mounted at any height or elevation relative to the female part of the casing, but the touch screen should be mounted such that proper alignment with the underlying view screen of the display is optimized. In one embodiment, the touch screen is attached to the inside of the female casing part with adhesive in a beveled shelf.

The two male and female casing pieces can be connected with any attachment device 170 including but not limited to hook and loop attachments, screws, nuts, bolts, clips, buttons, clasps, and adhesive. The attachment devices in FIG. 23 are inserted along the axis parallel to the touch screen. But, other embodiments may employ attachment devices along different axis or angles.

This embodiment would further enable easy manufacturing and maintenance because this apparatus can be constructed of two pieces of casing and the touch screen and controller with connection to the computing device. In FIG. 22, the controller and connection to the computing device are not shown, but different embodiments may place the controller and connection from the touch screen and controller and the connection between the controller and the computing device along different areas of either the male or female casing pieces. This invention also contemplates wireless connections and also computing devices with integrated controllers and connection devices. In addition, there needs to an associated software driver installed in the computing device.

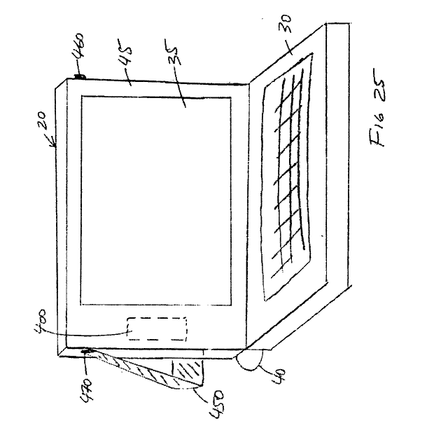

FIG. 24 Embodiment.

In another embodiment as shown in FIG. 24, the casing is comprised of a male 160 and female 165 pieces. The male piece comprises a first cavity 400 and a second cavity 410 and has three flanges (430, 435, 440) or prongs arising from the male casing piece. There is a first flange, a second flange, and a third flange. Generally, the first cavity will be much smaller than the second cavity; the first cavity will contain the controller for the touch screen and house the connection from the touch screen to the controller and the connection from the controller to the computer. The connection from controller 420 can go through the male casing as shown in FIG. 24 or can access the computing devices though other parts of the structure. The first cavity is formed from the first flange and the second flange.

The second cavity, which is formed from the second and third flanges, will hold the display for a computing device. This cavity may also be lined with felt or other non-scratching material to safely protect the outside of the display and to facilitate placement and removal of the slipcover apparatus.

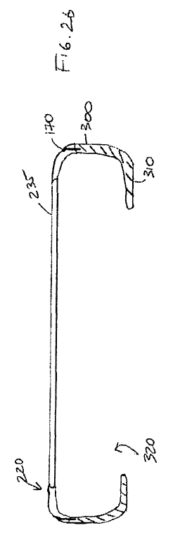

The male and female casing parts are securely connected with attachment devices, including but not limited to screws, bolts, clips, hook-lop attachment, button, clasps, or adhesives. FIG. 25 shows the slipcover apparatus placed upon the display of a notebook computing device.

In addition, as shown in FIG. 25, the outside surface of the slipcover apparatus can have a structure, which is both a strap 450 when placed in a first position and a stand placed in a second position. This strap/stand can be composed of metal, aluminum, plastic, or a composite. This strap or stand is attached to the outside surface of the female casing part and pivots about a first pivot point 460 and a second pivot point 470. In the first position, the strap is pivoted so that the user can lift the apparatus off the computing device. In the second position, the user will pivot the strap/stand from the first position to a second position, wherein the stand can be leaned against a surface such as a table or stable resting surface. The user can also remove this pivoting stand/strap by unscrewing or unfastening the pivot points.

In addition, in the structures shown in FIG. 24-25, the casing is larger than the display, but this size can vary depending on the particular dimensions of the first and second cavities. In addition, with further advances in computing technologies, it is understood that smaller devices may allow for smaller components and smaller first cavities.

FIG. 26:

Similar to the embodiment as shown in FIG. 21, this embodiment of the c-frame apparatus can be constructed not only of a single casing for the touch screen, but it is also possible to have a web or casing, which will house the touch screen, and separate pieces for the flange and arms as shown in FIG. 21. The flange and arm pieces can be connected to the casing/web with attachment devices, including but not limited to screws, nuts, bolts, or adhesives. Any separations between the casing/web and the side arm/flange pieces and any attachment devices can be covered with a covering layer, including but not limited to metal or mylar laminate. FIGS. 21 and 26 do not show any controller or connection from the controller to the computing device or connection from the touch screen to the controller, but it is understood that one skilled in the art would be able to integrate such connections and controllers anywhere within the structure of the web/casing or along one of the arm/flanges.

While the invention as described above in connection with preferred embodiments, it will be understood that it is not intended to limit the invention to those embodiments. On the contrary, it is intended to cover all alternatives, modifications, and equivalents as may be included within the spirit and scope of the invention as defined by the appended claims.

Any element in a claim that does not explicitly state “means for” performing a specific function, or “step for” performing a specific function, is not be interpreted as a “means” or “step” clause as specified in 35 U.S.C. Sec. 112, Paragraph 6. In particular, the use of “step of” in the claims herein is not intended to invoke the provisions of 35 U.S.C. Sec. 112, Paragraph 6.

1. A structure suitable for converting a non-touch screen display into a touch screen display for a computing device comprising:
A web having at least one web surface,
At least two flanges extend from the web,
Each of said flanges has an arm,
The web incorporates a touch screen, a controller for the touch screen and a connection from the controller of the touch screen to the computing device,
The web, flanges, and arms define a space for slidably engaging the display, and
A software driver for the touch screen controller,
Whereby the web is slidably positioned over said display for the computing device such that the touch screen in the web is oriented directly over the display to convert a non-touch screen display to a touch screen display.

2. The structure of claim 1 wherein said connection to said computing device is a USB, serial, firewire, wireless, and cable connection.

3. The structure of claim 1 wherein said web has at least one hole on the flange of the web to allow for at least one wire to pass through the web to connect to the display for hanging.

4. A method of using an apparatus suitable for converting a non-touch screen display into a touch screen display for a computing device, said structure suitable for converting a non-touch screen display into a touch screen display for a computing device comprising a web having at least one web surface,
At least two flanges extend from the web,
Each of said flanges has an arm,
The web incorporates a touch screen, a controller for the touch screen and a connection from the controller of the touch screen to the computing device,
The web, flanges, and arms define a space for slidably engaging the display,
A software driver for the touch screen controller,
Comprising the following steps:
Sliding the web around the display into the space defined by the web, flanges, and arms;
Attaching the connection from the controller of the touch screen to the computing device,
Installing the software driver for the touch screen controller into the computing device, and
Whereby the touch screen in the web is oriented directly over the display to convert a non-touch screen display to a touch screen display.
